(19) United States
(12) Patent Application Publication
(10) Pub. No.: US 2019/0061142 A1
(43) Pub. Date: Feb. 28, 2019

(54) Adjustable Lift Tray

(71) Applicant: Keith Kitowski, Bloomington, MN (US)

(72) Inventor: Keith Kitowski, Bloomington, MN (US)

(21) Appl. No.: 16/100,311

(22) Filed: Aug. 10, 2018

Related U.S. Application Data
(60) Provisional application No. 62/543,720, filed on Aug. 10, 2017.

(51) Int. Cl. B25H 5/00; B25H 3/06; B65D 21/08

(52) U.S. Cl. CPC B25H 5/00; B65D 21/086; B25H 3/06

(57) ABSTRACT

An adjustable lift tray which has two tray sections which overlap and are adjustably connected to each other to change the width of the lift tray and where each tray section has a rail so the adjustable lift tray can be connected to a lift.

### CROSS-REFERENCE TO RELATED APPLICATIONS

This Application claims the benefit of and priority to U.S. Provisional Application No. 62/543720, filed Aug. 10, 2017, the entire contents of which are herein incorporated by reference.

### STATEMENT REGARDING FEDERALLY SPONSORED RESEARCH

Not Applicable

### FIELD OF THE INVENTION

The invention relates to an adjustable tray and more specifically to an adjustable tray for use with an aerial device, such as an elevating work platform, also known as an aerial work platform, bucket truck or mobile elevating work platform.

### BACKGROUND OF THE INVENTION

Many workers have need to use an aerial work platform, which is a mechanical device used to provide temporary access for people or equipment to reach inaccessible areas, usually at height. Common types of these devices are called a “cherry picker”; a “scissor lift”, or a “bucket lift”.

The lift provides a platform surrounded by rails, for the protection of the workers using the lift. Workers will often have equipment, tools, parts and hardware such as bolts, nuts and so forth, which is usually set on the floor of the platform and which is hard to access and easy to drop or kick.

What is needed is a device which can easily hold tools, parts and hardware, where it is easy to reach, is portable and can be easily adjusted to work with a variety of different sized platforms.

### BRIEF SUMMARY OF THE INVENTION

An adjustable length tray that creates a work station, keeping tools, parts and other work items within easy reach and at about waist level. This tray can be used with various lift types, including, but not limited to, scissor lifts and aerial lifts.

An adjustable lift tray which has two tray sections which overlap and are adjustably connected to each other to change the width of the lift tray and where each tray section has a rail so the adjustable lift tray can be connected to a lift.

This is an adjustable tray comprised of two pieces with an option third piece insert to expand the length further. Two handles or rails for either sides of the tray are also an optional feature.

The two adjustable pieces are connected on the sides and on the bottom for easy adjustment and strength.

The adjustable lift tray has slots for adjusting the width of the lift tray, with fasteners used to secure the two tray sections at the desired width.

The tray sections can be made out of any desirable metal, plastic or fiberglass material.

### BRIEF DESCRIPTION OF THE DRAWINGS

FIG. 1 is a view showing the inventive adjustable lift tray installed on the rails of a lift.

FIGS. 2A-2D is a view showing the two parts of the adjustable tray assembly.

FIGS. 3A-3D is a view showing the other side of the two parts of the adjustable tray assembly.

FIG. 4 is a view showing an optional intermediate section to lengthen the width of the adjustable tray assembly.

FIGS. 5A-5B is a view showing the tray assembly adjusted to its narrowest and widest widths.

FIG. 6 is a view showing an optional drawer slide which can be used instead of nut and bolt fasteners to attach the parts of the tray assembly.

### DETAILED DESCRIPTION OF THE INVENTION

While this invention may be embodied in many forms, there are described in detail herein specific embodiments of the invention. This description is an exemplification of the principles of the invention and is not intended to limit the invention to the particular embodiments illustrated.

For the purposes of this disclosure, like reference numerals in the figures shall refer to like features unless otherwise indicated.

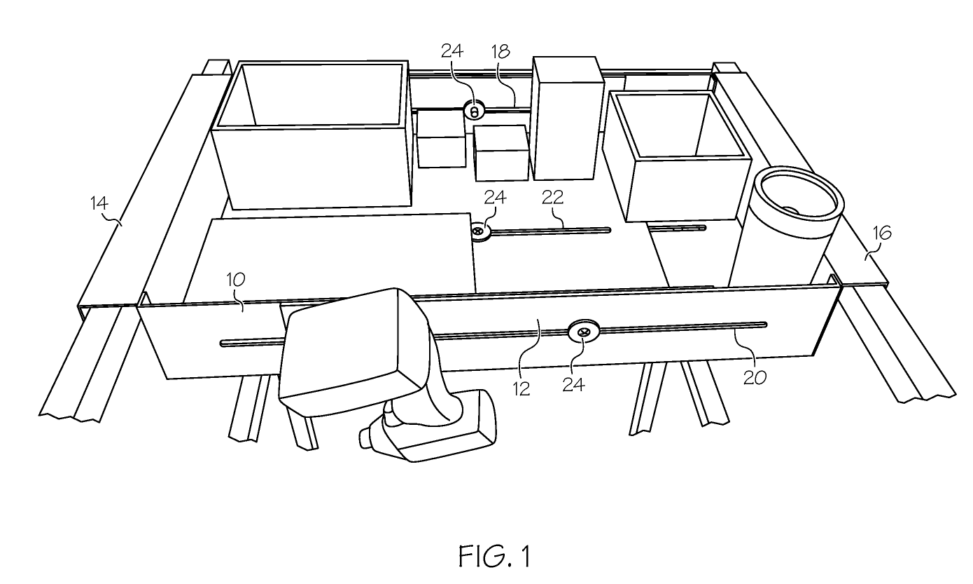

Referring now to FIG. 1, the inventive adjustable tray is shown installed on the rails of a lift. In this embodiment, the tray is made of two tray parts 10 and 12, with tray 10 being sized to fit inside of tray 12. Each tray 10 and 12 has side walls and a bottom, with flanges 14 and 16 at the end of each tray part 10, 12. The sides and bottom of each tray part have slots 18, 20 and 22, respectively, which are used to install fasteners 24, which can be a bolt and nut or any other type of conventional fastener. The two tray parts 10 and 12 are adjusted so the rails 14 and 16 can rest on the rails of the lift, and then the fasteners 24 are tightened to hold the tray at the desired width. The tray can be any desired depth.

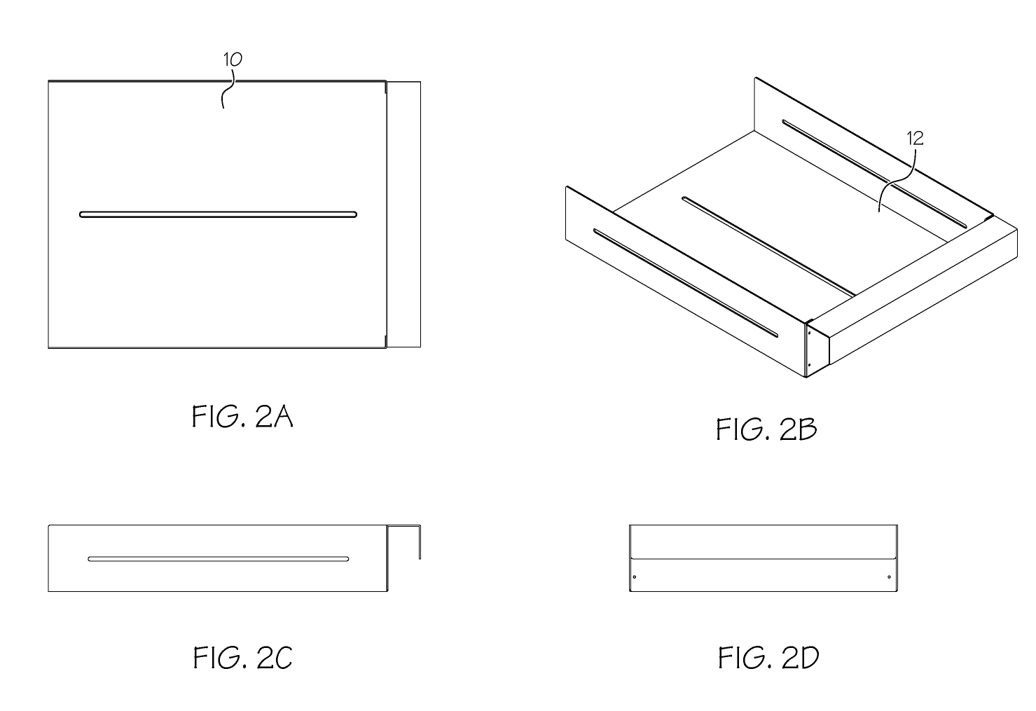

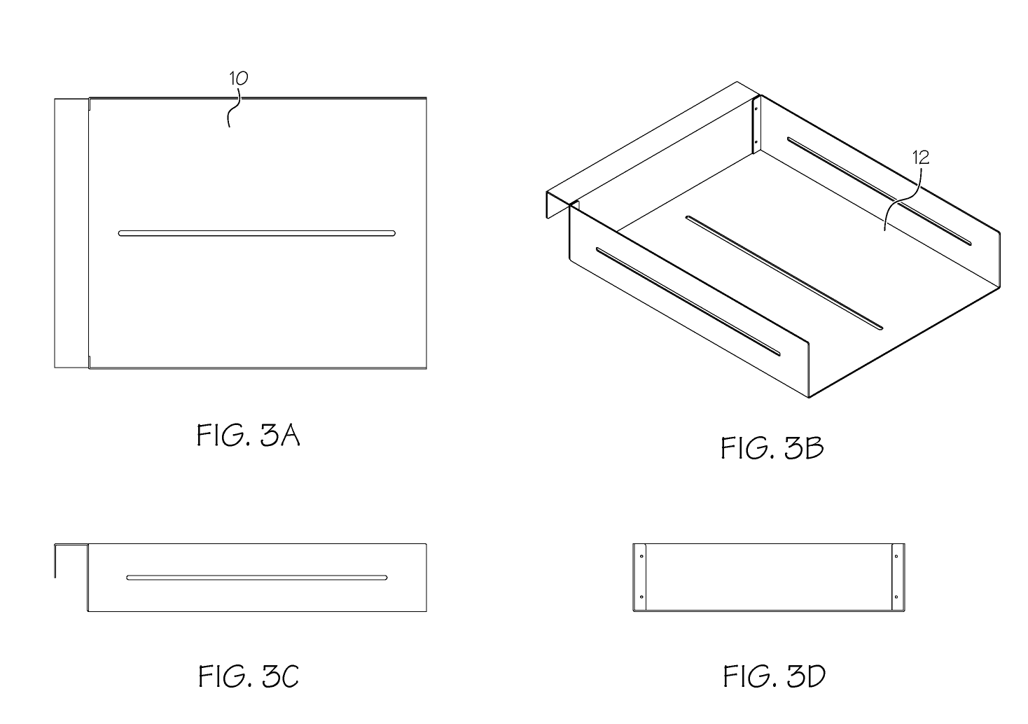

Referring to FIGS. 2A-2D and FIGS. 3A-3D, the two tray parts 10 and 12 are shown from two sides.

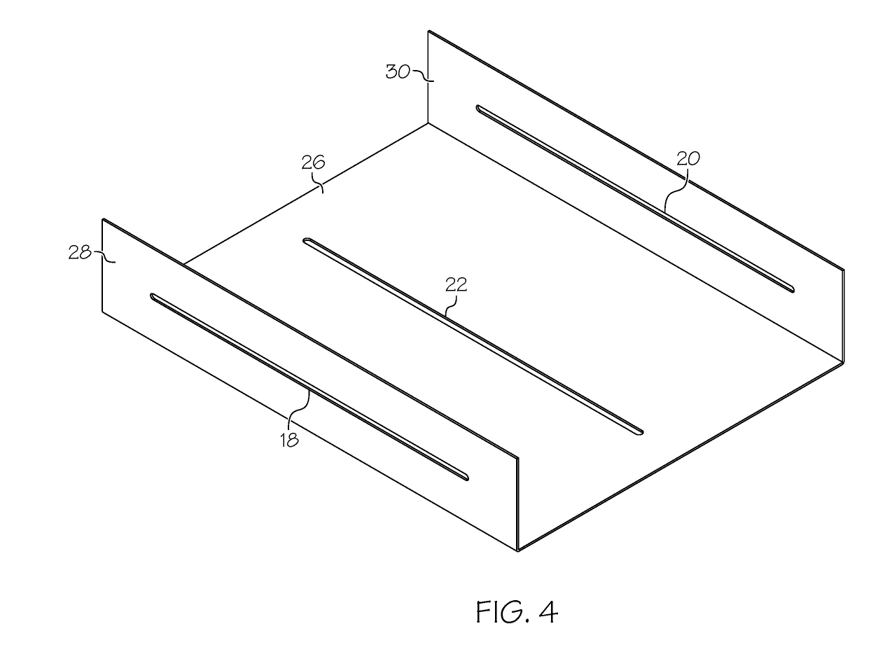

Referring to FIG. 4, an optional intermediate tray section is shown which can be added to lengthen the two part tray assembly of FIG. 1. The tray part is comprised of a bottom side 26, and two opposing sides 28 and 30, each side having a slot 18, 20 and 22. The optional insert is comprised of a bottom and two long sides, but no short sides. This piece also has slots lengthwise along the bottom, and lengthwise along each of the sides. This piece connects to the tray using the adjusters 24 that come with the tray.

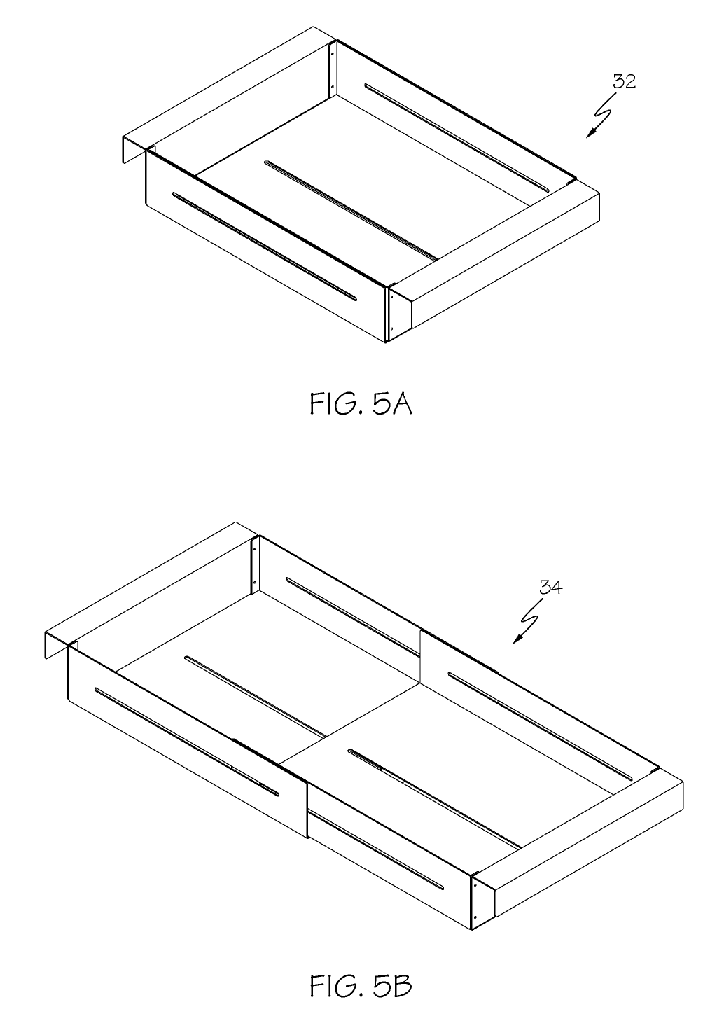

Referring to FIGS. 5A-5B, the adjustable tray is shown generally at 32 at its narrowest and at 34 at its widest width.

The tray parts can be made out of any metal, such as Aluminum, or any plastic or fiberglass material. In one embodiment the tray parts are made out of 80 Aluminum, which can easily hold 50 lbs of tools, parts and various hardware.

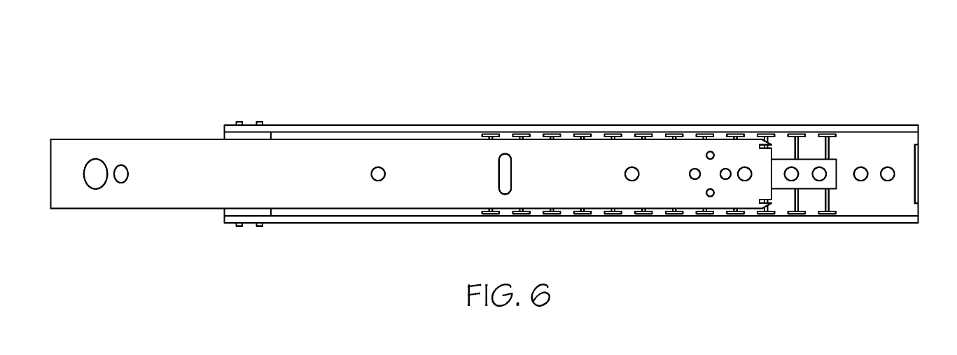

Referring now to FIG. 6, two optional drawer slides shown could be used on the two sides, to allow the tray to adjust, rather than nut and bolt hardware. The bottom fastener could be eliminated if desired.

Although not shown in the figures, optional handles could be added to the rails or flanges 14 and 16, to allow the adjustable tray to be easily lifted.

What is claimed is:

1. An adjustable lift tray comprising:
two tray sections which overlap and are adjustably connected to each other to change the width of the lift tray;
each tray section having a rail so the adjustable lift tray can be connected to a lift.

2. The adjustable lift tray of claim 1 wherein each tray section has a bottom side, a front side, a back side and an outside side connecting the front side and back side, the outside side including the rail for connecting the lift tray to the lift.

3. The adjustable lift tray of claim 1 wherein front side and back side have slots for adjusting the width of the lift tray, with fasteners securing the two tray sections to each other through the slots.

4. The adjust able lift tray of claim 3 wherein the two tray sections are made out of metal.

5. The adjust able lift tray of claim 3 wherein the two tray sections are made out of plastic.

6. The adjust able lift tray of claim 3 wherein the two tray sections are made out of fiberglass.

7. An adjustable lift tray comprising:
an intermediate section with a bottom side having right and left edges, a front side and a back side;
two tray sections which overlap with the right and left edges of the intermediate section and are adjustably connected to the intermediate section to change the width of the lift tray;
each tray section having a rail so the adjustable lift tray can be connected to a lift.
